(19) United States
(12) Patent Application Publication
(10) Pub. No.: US 2017/0285970 A1
(43) Pub. Date: Oct. 5, 2017

(54) Information Handling System Persistent Storage Device Life Management

(71) Applicant: Dell Products L.P., Round Rock, TX (US)

(72) Inventors: Wen Hua Li, Singapore (SG); Joo Kiang Low, Singapore (SG)

(73) Assignee: Dell Products L.P., Round Rock, TX (US)

(21) Appl. No.: 15/084,920

(22) Filed: Mar. 30, 2016

(51) Int. Cl. G06F 3/06

(52) U.S. Cl. CPC G06F 3/0616; G06F 3/0653; G06F 3/0679

(57) ABSTRACT

A portable information handling system solid state storage device monitors thermal conditions to more accurately track program/erase cycles. The program/erase count maintained by the solid state drive is adjusted upward or downward as deviations from a threshold thermal condition warrants.

### BACKGROUND OF THE INVENTION

### Field of the Invention

The present invention relates in general to the field of information handling system storage devices, and more particularly to an information handling system persistent storage device life management.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems typically include integrated storage devices that retain information when power is not applied. Conventional persistent storage devices generally include hard disk drives and flash memory integrated circuit devices. Hard disk drives store information on a spinning magnetic disk that is written and read by a head placed over the disk, and are commonly found in portable information handling systems to store an operating system and applications that are booted on system power up. Flash memory devices work without moving parts to write and read information through a bus or serial link when power is applied. Flash memory devices have traditionally been used to store firmware instructions, such as a system BIOS, that are used to boot information from hard disk drives. Flash memory devices consolidated into storage drives provide an alternative to hard disk drives for providing persistent storage in information handling systems. The price and performance of flash memory devices has improved over time to reach a level that makes flash memory a viable option for use in the place of hard disk drives. As a result, solid state drives made of flash memory have been adopted in portable information handling systems at competitive price and performance levels.

One difficulty associated with solid state drives is that flash memory tends to have a limited life that depends upon how much the memory is programmed and erased. Solid state drive manufacturers classify device life with a projected P/E cycle parameter that quantifies the device endurance. The projected P/E cycle value is generally determined as a function of four factors: 1. The NAND technology used to build the device; 2. The data retention requirement that defines the duration to store data without any reflash; 3. Temperature at the device; and 4. Controller error correction capabilities. Manufacturers typically determine a storage device's P/E cycle value with JEDEC JESD 218 based upon the intended use of a solid state drive in a client or enterprise class. Client class systems are tested under an operating temperature of 40 degrees Celsius, a retention temperature of 30 degrees Celsius and a one year data retention. Enterprise class systems are tested under an operating temperature of 55 degrees Celsius and a retention temperature of 40 degrees Celsius. The operating temperature relates to periods of active writes at the flash memory. The retention temperature relates to idle storage time during which the flash memory retains information without writing. Operating temperatures are typically higher than retention temperatures in the field since the flash memory is expending energy to perform writes and the expended energy creates thermal energy as a byproduct. Information handling system manufacturers use the standardized P/E values as a benchmark for predicting storage device endurance once installed in a client or enterprise environment. As a storage device is used in a system, actual usage is compared against the benchmark to predict storage device end of life.

With the increased use of portable devices and Internet of Things (IoT) architectures, operating conditions that information handling systems experience can vary widely. For example, operating temperatures in such devices may occasionally reach 70 degrees Celsius. In addition, data retention requirements have tended to decrease in such devices. These environmental factors tend to impact storage device life span in a detrimental manner that is often unpredictable so that devices fail prematurely or are taken out of service before actual end-of-life. Information handling system manufacturers tend to face increased costs due to setting more stringent design characteristics that call for more robust and typically more expensive storage devices.

### SUMMARY OF THE INVENTION

Therefore, a need has arisen for a system and method which manages an information handling system storage device life cycle.

In accordance with the present invention, a system and method are provided which substantially reduce the disadvantages and problems associated with previous methods and systems for managing information handling system storage device life cycles. A solid state storage device controller tracks remaining life of integrated flash memory with a program/erase value reflecting wear caused by program and erase cycles. The controller monitors thermal conditions associated with the flash memory and adjusts the program/erase value based upon proportionate deviation of the monitored thermal conditions from a threshold.

More specifically, a portable information handling system processes information with a processor and memory integrated in a portable housing. Thermal conditions within the portable housing are monitored with thermal sensors interfaced with the processing components. For example, an embedded controller that executes a BIOS receives sensed thermal conditions from a CPU, RAM cooling infrastructure, etc. As another example, a thermal sensor integrated in a solid state storage device is periodically sampled by a controller of the solid state storage device. The solid state storage device tracks remaining life by monitoring program/erase cycles, such as with a program/erase log kept by the controller that counts cycles. Sensed thermal conditions are applied to adjust the program/erase cycle count value to more accurately tracking remaining life of flash memory in the solid state storage device, such as by increase the count of program/erase cycles during increased thermal conditions so that the remaining life reflects a reduced amount based upon a greater program/erase count than has actually occurred.

The present invention provides a number of important technical advantages. One example of an important technical advantage is that storage device life cycle is more accurately predicted for detected operating conditions so end of life is more accurately predicted at system manufacture and more accurately tracking during system operation. More accurate matching of storage devices to anticipated use in information handling systems reduces system design and manufacture costs by providing storage devices with life cycles fitted to the anticipated use and operating conditions. Adjusting P/E cycle values based upon detected operating conditions provides an end-of-life warning to end users so that unexpected failures are avoided and aged equipment is replaced in a timely and cost-efficient manner. This provides enhanced value to end users who deploy portable systems in adverse operating conditions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system having a solid state storage device with remaining life adjusted for sensed thermal conditions;

FIG. 2 depicts a block diagram of a solid state storage device that adjusts program/erase values for thermal conditions;

FIG. 3 depicts a graph that illustrates an example of data retention simulation based upon data retention testing performed at an elevated temperature; and

FIG. 4 depicts a flow diagram of a process for monitoring thermal conditions within a solid state storage device.

### DETAILED DESCRIPTION

An information handling system solid state storage device end of life is more accurately tracked by adjusting program/erase cycle values based upon detected thermal conditions. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

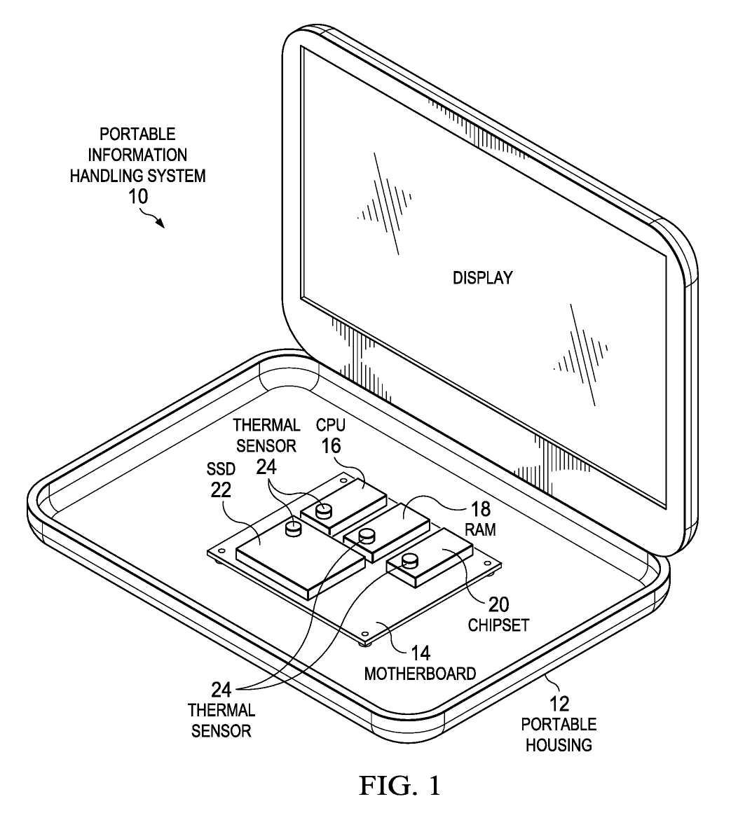

Referring now to FIG. 1, a portable information handling system 10 is depicted having a solid state storage device 22 with remaining life adjusted for sensed thermal conditions. Portable information handling system 10 is built in a portable housing 12 that supports portable operations with an integrated power supply, processing components and input/output devices, such as touchscreen display that accepts inputs and presents information as visual images. In the example embodiment, portable housing 12 has rotationally coupled housing elements, however, in alternative embodiments tablet or other housing configurations may be used. A motherboard 14 disposed in portable housing 12 interfaces processing components that cooperate to process information. For example, a central processing unit 16 executes instructions stored in random access memory (RAM) 18 under the management of various processors and controllers of a chipset 20 that execute firmware instructions, such as a Basic Input/Output System (BIOS). For example, chipset 20 includes a keyboard controller that manages I/O devices and application of power at the processing components.

In the example embodiment, portable information handling system 10 includes a solid state drive (SSD) 22 that provides persistent storage of information during power down cycles. For example, SSD 22 stores applications that provide instructions and information to CPU 16 for execution based upon commands received from an end user. In the example embodiment, SSD 22 includes a dynamic program/erase (P/E) cycle value that adjusts an estimated remaining life of SSD 22 based upon detected thermal conditions as sensed by one or more thermal sensors 24 disposed in portable housing 12. At manufacture, SSD 22 is programmed with a projected P/E cycle value that reflects the expected number of P/E cycles available for SSD 22. The projected P/E cycle value indicates expected SSD endurance based upon the four main factors described above with the temperature value standardized as provided by the JEDEC protocol. SSD 22 adjusts the P/E value based upon sensed thermal conditions provided by thermal sensors 24 so that the impact of thermal conditions above or below a threshold on storage endurance is reflected in the P/E value for expected endurance remaining. In this manner, if SSD 22 experiences higher thermal conditions than the JEDEC protocol, the expected life is adjusted downward so that a more realistic time of failure is available to an end user. Similarly, if SSD 22 experiences lower thermal conditions than the JEDED protocol, the expected life is adjusted upward so that time of failure is moved farther out and SSD 22 is not prematurely replaced. As is explained in greater depth below, thermal conditions are monitored during idle periods for comparison against standardized retention temperatures (i.e., 30 degrees Celsius for client class systems and 40 degrees Celsius for enterprise class systems). If monitored thermal conditions deviate from standardized retention temperatures, adjustments to the P/E cycle value are made in proportion to the deviation so that storage device end of life is more accurately predicted and tracked.

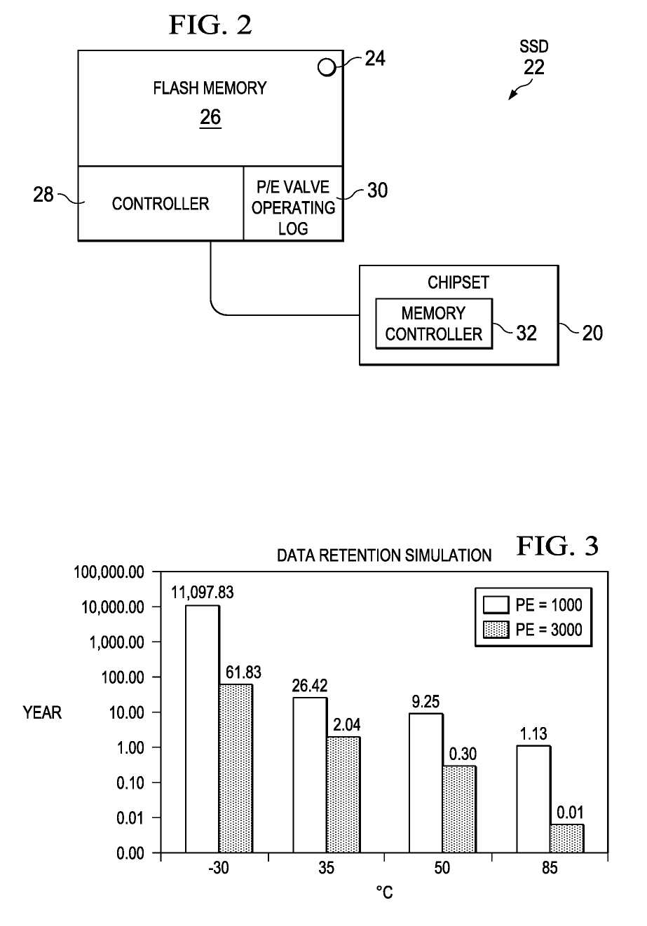

Referring now to FIG. 2, a block diagram depicts a solid state storage device 22 that adjusts program/erase values for thermal conditions. SSD 22 integrates flash memory 26, such as NAND memory, and a controller 28 in a housing having a thermal sensor 24 to monitor thermal conditions as flash memory 26. Controller 28 includes a P/E value operating log 30 that counts P/E cycles performed at flash memory 26. Controller 28 compares the count of P/E cycles with a threshold endurance to track remaining life of SSD 22. In various embodiments, P/E value operating log 30 may track the number of P/E cycles by adding to a count as a P/E cycle occurs or may count down from a maximum value to zero as P/E cycles occur. Controller 28 interfaces with an external device to communicate information for reading and writing, such as a memory controller 32 included in a portable information handling system chipset 20. Memory controller 32 includes an interface that provides operating information of SSD 22 to other information handling system assets, such as an operating system executing on a CPU. Thus, for example, as SSD 22 approaches its end of life, a message from controller 28 communicated to memory controller 32 provides notice of the end of life to an end user through an operating system user interface. In one example embodiment, memory controller 32 provides updates to controller 28 that allow controller 28 to more accurately tracking remaining endurance of SSD 22. For example, as field experience from deployed SSD's 22 becomes available, firmware updates provided through an operating system interface to memory controller 32 update the dynamic P/E value determination at controller 28 for more precise end-of-life tracking.

Initially, dynamic P/E cycle values for a desired data retention requirement are calculated from experimental data that determines actual data retention at increased thermal conditions. In one example embodiment, a set of production SSD 22 samples are placed in a heated environment to test endurance, such as at 125 degrees Celsius. After performing different program/erase cycles at standardized temperatures, information is periodically read from the SSDs at the increased temperature and the read back bit error rates are sampled until an excessive bit error rate occurs that indicates excessive flash memory wear. The excessive bit error rate is determined by the SSD controller's error correction capability. The times required to reach the excessive bit error rate are considered the data retention times for the SSDs of different program/erase cycles at the higher temperature. Once the high temperature data retention limits are determined for different program/erase cycle samples, an adjustment factor for calculating the SSD data retention under different temperatures is calculated based upon following formula:

AF=exp{(H/K)[1/T1−1/T2]}

Where:

K=Boltsmann's constant (8.617×10⁻⁵ in ev/K)

H=activation energy as defined by the NAND supplier

T1=T use in Kelvin, temperature under calculation.

T2=T stress in Kelvin, temperature used in above experiment.

Referring now to FIG. 3, a graph illustrates an example data retention simulation based upon data retention testing performed at an elevated temperature. Once data retentions are determined at the elevated thermal condition, the above formula is applied to determine the relationship between data retentions of different P/E cycles at intermediate temperatures. The SSD data retention under intermediate temperature is simply AF multiplied by the data retention under the high elevated temperature. A projected data retention table at varying P/E cycle counts and temperatures is prepared for selected data points and intermediate values are interpolated as needed. Once the data retention table is defined for a given SSD, the projected P/E cycle value for a data retention requirement are determined at different temperatures and stored in P/E operating log 30 for reference by controller 28. The example embodiment provides a basis for determining thermal condition deviation during non-operating idle time where data is retained without write operations. To provide a like comparison for adjusting P/E cycle values, the storage device performs thermal conditions during idle times, such as after a period of time passes in which no writes have been performed.

In operation, controller 28 samples thermal conditions based on predetermined conditions, such as at periodic events or periodic time intervals. When a sensed thermal condition deviates from a standardized thermal condition by a threshold amount, controller 28 adjusts projected P/E cycle values stored in projected P/E operating log 30 to account for changes in expected life introduced by the thermal deviation. For example, temperatures above a threshold value decrease expected SSD endurance by decreasing the projected P/E cycle count kept by controller 28 in proportion to the increased temperature. Similarly, temperatures below a threshold value increase expected SSD endurance by increasing the projected P/E cycle count kept by controller 28 in proportion to the decreased temperature. The adjustment to expected remaining life may be accounted for by changing the end-of-life P/E value against which the P/E count is compared. In one alternative embodiment, chipset 20 may provide P/E value adjustments in the place of controller 28 or in addition to those kept by controller 28, such as to reflect thermal conditions sensed outside SSD 22. Interacting with chipset 20 provides a vehicle for updating P/E value operating log 30 as field experience provides more accurate prediction of SSD life. In one embodiment, thermal conditions tracked at SSD 22 are provided through the Internet to a centralized data repository so that actual field bit error and temperature relationships are analyzed over time. The field analysis of the impact of thermal environmental conditions on bit error rates improves adjustment factor accuracy across a range of detected thermal conditions. These more accurate adjustment factor values are then deployed via firmware updates to SSDs 22 installed in portable information handling systems in the field.

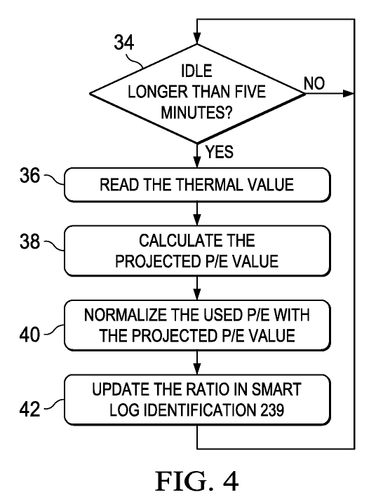

Referring now to FIG. 4, a flow diagram of a process for monitoring thermal conditions within a solid state storage device. The process starts at step 34 with detection of an idle time of longer than five minutes. An idle time of 5 minutes indicates that the storage device is in a retention thermal state instead of an operating thermal state as considered under the JDEC standards. In alternative embodiments, alternative idle periods may be applied as desired to ensure that thermal comparisons are performed in the retention thermal state. Once an idle time of five minutes or greater is detected, the process continues to step 36 to read sensed thermal values from a thermal sensor proximate the flash memory. At step 38, a projected P/E value is calculated based upon the sensed thermal conditions applied to the adjustment factor. At step 40, the stored P/E cycle value is normalized by applying an adjustment that reflects the calculated P/E value from step 38. For example, even if no writes have occurred, the P/E value is increased as if writes had occurred should the thermal conditions exceed a threshold. The amount of the increase of the P/E value depends upon the degree to which the thermal conditions exceed the threshold, where higher temperatures add a greater increase to the P/E value to decrease the expected life of SSD 22 by a greater amount. At step 42, the adjusted P/E cycle value is updated to the SSD 22 log 30 so that comparisons with an end of life P/E value are made with log 30′s thermally adjusted P/E value. In alternative embodiments, the P/E value count is maintained consistent and without adjustment while the projected maximum P/E value is adjusted based upon thermal conditions.

Although the present invention has been described in detail, it should be understood that various changes, substitutions and alterations can be made hereto without departing from the spirit and scope of the invention as defined by the appended claims.

1. A portable information handling system comprising:
a housing;
a processor disposed in the housing and operable to execute instructions to process information;
a memory disposed in the housing and interfaced with the processor, the memory operable to store the information;
a solid state storage device disposed in the housing and having flash memory;
a controller integrated with the solid state storage device and operable to coordinate reads and writes of information to the flash memory, the controller tracking flash memory life based at least in part on a program/erase value;
a temperature sensor disposed in housing and operable to detect thermal conditions proximate the solid state storage device;
a chipset operable to coordinate interactions between the processor, memory and controller; and
a program/erase log integrated in the solid state storage device and storing a program/erase value adjusted for thermal conditions sensed by the temperature sensor.

2. The portable information handling system of claim 1 wherein the temperature sensor is integrated in the solid state storage device and interfaced with the controller, the controller periodically adjusting the program/erase log program/erase value based upon detected thermal conditions.

3. The portable information handling system of claim 2 wherein the controller samples thermal conditions to update the program/erase value at five minute intervals.

4. The portable information handling system of claim 2 wherein the controller retrieves the program/erase value from the program/erase log, determines an adjusted program/erase value and replaces the program/erase value stored in the program/erase log with the adjusted program/erase value.

5. The portable information handling system of claim 2 wherein the controller is further operable to issue a warning at a predetermined remaining flash memory life.

6. The portable information handling system of claim 2 wherein the controller decreases the program/erase value in proportion to detected thermal conditions above a threshold and increases the program/erase value in proportion to detected thermal conditions below a threshold.

7. The portable information handling system of claim 1 wherein the chipset detects thermal conditions from the temperature sensor and applies the thermal conditions to adjust the program/erase cycle stored in the program/erase log.

8. The portable information handling system of claim 7 wherein the chipset issues a warning if the program/erase cycle deviates by greater than a predetermined amount from an expected value.

9. A method for managing storage device life at a portable information handling system, the method comprising:
monitoring the number of program/erase cycles of a storage device in a program/erase log stored on the information handling system;
monitoring temperatures proximate the storage device; and
adjusting the number of program/erase cycles in the program/erase log based upon the temperatures.

10. The method of claim 9 further comprising:
increasing the number of program/erase cycles counted in the program/erase log if the temperature is greater than a threshold; and
decreasing the number of program/erase cycles counted in the program/erase log if the temperature is less than a threshold.

11. The method of claim 10 further comprising:
monitoring temperatures with a temperature sensor integrated in the storage device; and
adjusting the number of program/erase cycles with a controller integrated in the storage device.

12. The method of claim 11 further comprising:
monitoring temperatures with a temperature sensor external to the storage device; and
adjusting the number of program/erase cycles with an embedded controller external to the storage device.

13. The method of claim 11 wherein adjusting the number of program/erase cycles further comprises communicating an adjusted program/erase value from an embedded controller to a controller integrated in the storage device.

14. The method of claim 11 wherein adjusting the number of program/erase cycles further comprises storing an adjustment factor in the embedded controller and applying the adjustment factor to a program/erase value read from a controller integrated in the storage device.

15. A solid state storage device comprising:
flash memory operable to persistently store information;
a controller interfaced with the flash memory and operable to read and write information at the flash memory;
a temperature sensor interfaced with the controller and operable to detect thermal conditions proximate the flash memory; and
a program/erase log interfaced with the flash memory and storing a program/erase value related to remaining flash memory life;
wherein the controller is further operable to adjust the program/erase value based on the thermal conditions.

16. The solid state storage device of claim 15 wherein the controller is further operable to:
monitor the number of program/erase cycles performed at the flash memory; and
increase the number of program/erase cycles if the thermal conditions exceed a threshold.

17. The solid state storage device of claim 16 wherein the controller is further operable to:
decrease the number of program/erase cycles if the thermal conditions fall below a threshold.

18. The solid state storage device of claim 17 wherein the controller is further operable to issue an end-of-life warning at a predetermined program/erase cycle value.

19. The solid state storage device of claim 15 wherein the controller is further operable to accept program/erase value adjustments from an external controller based upon thermal conditions detected by the external controller.

20. The solid state storage device of claim 15 wherein the controller performs a thermal condition evaluation at predetermined regular intervals.
